(19) United States
(12) Patent Application Publication
(10) Pub. No.: US 2019/0344365 A1
(43) Pub. Date: Nov. 14, 2019

(54) WORKPIECE LIMITING DEVICE FOR POWER TOOLS

(71) Applicant: TTI (MACAO COMMERCIAL OFFSHORE) LIMITED, Macau (MO)

(72) Inventor: Wai Tong CHAN, Kwai Chung (HK)

(21) Appl. No.: 16/404,785

(22) Filed: May 7, 2019

(30) Foreign Application Priority Data
May 9, 2018 (CN) 201820689441.0

(51) Int. Cl. B23D 47/02; B27B 5/29; B27G 19/02

(52) U.S. Cl. CPC B23D 47/025; B23D 45/042; B27G 19/02; B27B 5/29

(57) ABSTRACT

A workpiece limiting device for power tools includes a support arm adapted to contact with a workpiece and limit the workpiece, and a body. The support arm is supported by the body and movable relative to the latter. The workpiece limiting device further includes a quick-release device. The quick-release device allows manual adjustment of the position of the support arm relative to the body and locks this position without using an external tool. Through the workpiece limiting device, the adjustment range of the position of the support arm relative to the power tool can be greatly expanded, and workpieces in different sizes can be processed.

### FIELD

The utility model relates to a workpiece limiting device used in combination with a power tool such as a miter saw, and in particular to a distance adjusting structure on the workpiece limiting device.

### BACKGROUND

Miter saws are commonly used power tools for processing wood material. The main feature of miter saws is that the rotating saw wheel can be pressed vertically downward to cut the workpiece, and the saw wheel can be tilted to the left and right sides in a certain extent, so as to achieve a variety of cutting effect. The miter saw is usually mounted on stands, and such stands are typically equipped with workpiece limiting devices. This is because structures such as baffles and the like as part of the miter saw generally are only capable of posititioning the portion of the wood to be cut in the width direction of the wood, but it is not possible to limit the portion to be cut in the length direction of the wood. The workpiece limiting device solves this problem precisely, which may precisely position the support arm of the workpiece in the length direction of the workpiece so that the workpiece can be abutted against the support arm to position relative to the miter saw itself, so that the cutting takes place exactly on the desired part of the workpiece. Such a precise positioning can be performed for example by a servo motor which could achieve millimeter-level accuracy.

However, conventional workpiece limiting devices usually are adapted to achieve only one-level distance adjustment. That is, the adjustment range of the position of the support arm of the workpiece limiting device contacting the workpiece is at most equal to the length of the entire workpiece limiting device. Such a limited adjustment range is often insufficient in actual applications. Therefore, it is desired to achieve a sufficiently large range of distance adjustment of workpiece limiting, and such adjustment needs to be simple and convenient, and can be easily performed by the user.

### SUMMARY

The object of the utility model is to solve the above technical problems or at least alleviates the impact thereof.

In one aspect of utility model, a workpiece limiting device for power tools is disclosed that includes a support arm adapted to contact the workpiece and limit the workpiece, and a body. The support arm is supported by the body and movable relative to the latter. The workpiece limiting device further includes a quick-release device. The quick-release device allows manual adjustment of the position of the support arm relative to the body and locking the position without using an external tool.

Preferably, the quick-release device is adapted to achieve the locking by applying a frictional force to the support arm.

More preferably, the quick-release device comprises a clamping device. The clamping device is coupled to the body and the clamping device is adapted to clamp the support arm to create a frictional force.

In a variation of the preferred embodiment, the clamping device contains a first clamping member and a second clamping member. The first clamping member and the second clamping member are adapted to clamp the support arm together. The quick-release device further includes a user switch to adjust a distance between the first clamping member and the second clamping member to achieve the locking.

In another variation of the preferred embodiment, the user switch is a handle having a cam surface. The handle is adapted to rotate to cause the cam surface to press against one of the first clamping member and the second clamping member, so that the one of the first clamping member and the second clamping member moves closer to the other one of the first clamping member and the second clamping member to achieve the locking.

In an embodiment, the first clamping member has a first clamping surface and the second clamping member has a second clamping surface. The first clamping surface and the second clamping surface are substantially parallel. The user switch is adapted to adjust the distance between the first clamping surface and the second clamping surface.

In another embodiment, the support arm has a diamond-shaped cross section at least at a position proximate to the clamping device.

In still another embodiment, the workpiece limiting device further includes a slide rail. The slide rail is adapted to be fixedly mounted relative to the power tool. The body is movably supported on the slide rail.

In still another embodiment, the support defines a length direction. The length direction is parallel to the length direction of the slide rail.

In still another embodiment, the support is adapted to contact the workpiece from the length direction of the workpiece.

Another aspect of the present invention provides a power tool system including the above workpiece limiting device, a power tool stand, and a power tool mounted to the power tool stand. The workpiece limiting device is mounted on the power tool stand.

Preferably, the power tool is a miter saw.

The workpiece limiting device of the utility model therefore provides two levels of distance adjustment. Specifically, in addition to the body of the workpiece limiting device being movable on the slide rail to provide the first level of distance adjustment (for example, by a servo motor), the support arm can also be moved relative to the body of the workpiece limiting device, thereby providing the second distance adjustment. In this way, the range of support distance of the entire workpiece limiting device to the workpiece is greatly expanded, so that the workpiece can be positioned relative to the miter saw within a wide range, which is convenient for the user to process the workpieces having different lengths.

In addition, the workpiece limiting device of the utility model uses a simple and easy-to-use handle to lock or unlock the movement of the support arm relative to the body. Such a handle is directly operated by the user and can be manipulated out with one hand, which ensures that the support arm can be locked securely and can be adjusted as needed.

### BRIEF DESCRIPTION OF THE DRAWINGS

The performance and advantages of the present invention will be further understood with reference to the remainder of the specification and the accompanying drawings. Same components in the drawings have the same reference number.

FIG. 1 shows a perspective appearance view of a power tool system in accordance with an embodiment of the present invention, with a miter saw and a workpiece limiting device mounted on the power tool stand.

FIG. 2 partially shows a view appearance of the handle, support arm, and body on the workpiece limiting device of FIG. 1.

FIG. 3 shows a configuration of the two clamping members of the workpiece limiting device, and the handle is shown in transparence.

FIGS. 4a and 4b respectively show the state in which the workpiece limiting device provides a minimum and maximum distance relative to the miter saw.

### DETAILED DESCRIPTION

Embodiments of the present invention use frictional force to lock and unlock the support arm relative to the body of the workpiece limiting device. Other different benefits and advantages provided by the various embodiments of the present invention are readily apparent from the following description.

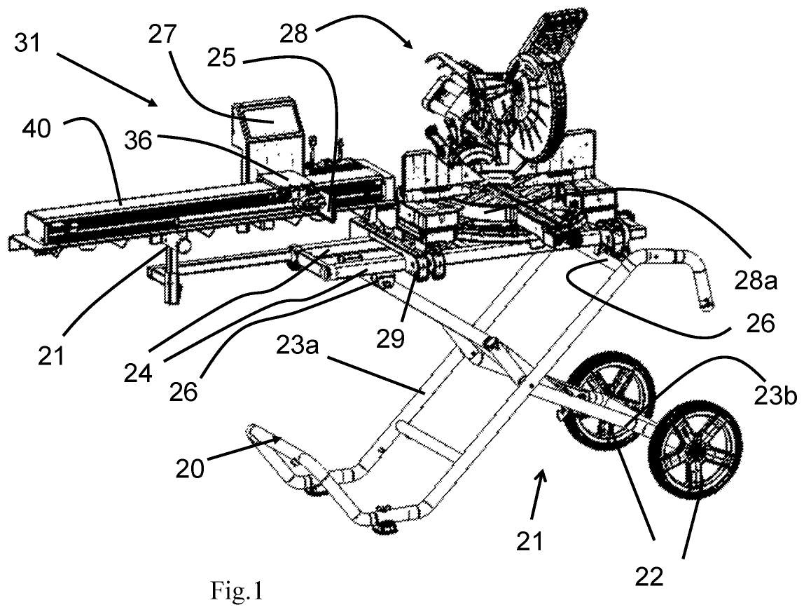

Firstly referring to FIG. 1, in which a power tool stand 21 is shown. The power tool stand 21 has a foldable structure, and FIG. 1 shows its fully deployed state. Specifically, the power tool stand 21 includes a first stand 23a and a second stand 23b, both of which are coupled together in a relatively rotatable manner by a hinge (not shown). The first stand 23a and the second stand 23b together constitute a stand body. At one end of the first stand 23a, a grip portion 20 for gripping by a user is formed. At one end of the second stand 23b, a wheel 22 is disposed. The other end of the second stand 23b and the other end of the first stand 23a are respectively connected to both ends of two mutually parallel crossbars 24 by two pivotable connecting members 26. By the above structures, the power tool stand 21 can be folded to become a flat-like structure to facilitate the user push the power tool stand 21 to move on the ground through the wheels 22. Alternatively, the user can also deploy the power tool stand 21 into the state shown in FIG. 1, at which time the wheel 22 and the grip 20 become fulcrums by which the entire power tool stand 21 stands on the ground. On the crossbar 24, a power tool, in this embodiment a miter saw 28, is mounted. In addition, on the crossbar 24, a workpiece limiting deviceper 31 is also mounted. The main structure and folding method of the power tool stand 21 described above are well known to those skilled in the art and will not be described herein.

The workpiece to be cut (not shown) is placed on a table 28a of the miter saw 28 during the cutting operation, and one end of the workpiece abuts against one end of the support arm 25 of the workpiece limiting device 31. By adjusting the position of the support arm 25 of the workpiece limiting device 31, the user can be assisted in accurately positioning the portion of the workpiece to be cut by the miter saw 28 in the length direction of the workpiece. The structure of the workpiece limiting device 31 will be specifically described below.

The workpiece limiting device 31 includes a control portion 27 and a slide rail 40, both of which are fixed relative to the power tool stand 21 described above and thus fixed relative to the miter saw 28. This is because the workpiece limiting device 31 as a whole is fixed to the crossbar 24 of the power tool stand 21 by the fixing stand 29. It should be noted that the workpiece limiting device 31 can be moved relative to the miter saw 28, such as when the user deploys the power tool stand 21 to prepare for the cutting operation, the user can move the workpiece limiting device 31 and the miter saw 28 for proper positioning. However, after the cutting preparation is completed, the stand 29 is locked to lock the position of the workpiece limiting device 31 (specifically, the slide rail 40) relative to the miter saw 28.

The control portion 27 is for use by a user to control the position of the body 36 supported on the slide rail 40 and movable relative to the slide rail 40. The movement of the body 36 is performed by a servo motor (not shown), and its specific moving direction and amplitude are set by the control portion 27. The control portion 27 may include, for example, a user interaction device such as a display screen and a button or the like (none of which is shown). The working principles of such control portion 27, body 36 and servo motor are well known to those skilled in the art and will not be described again here.

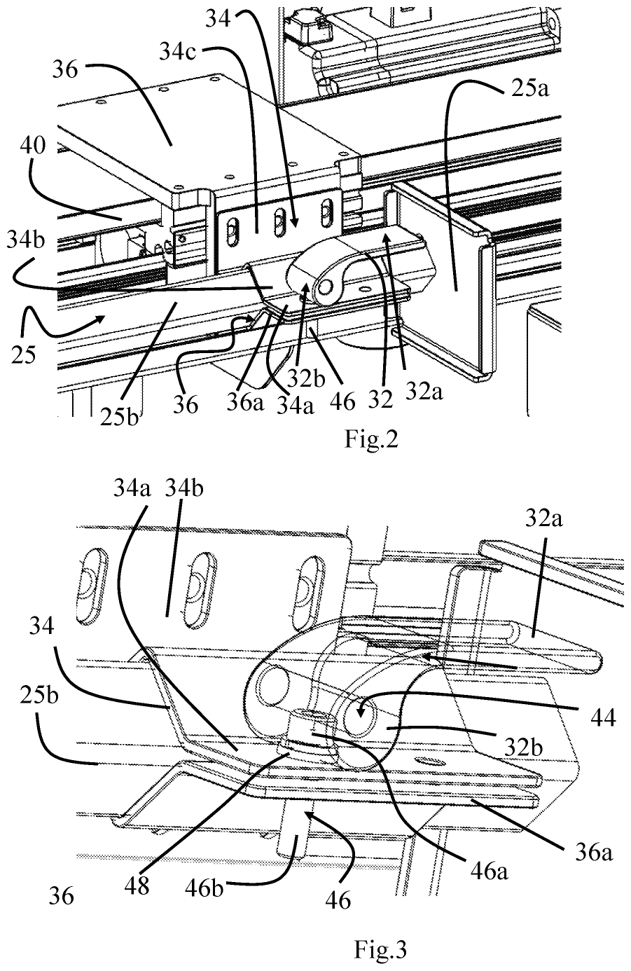

Turning to FIGS. 2 and 3, the structures of the body 36 of the workpiece limiting device 31 and the quick-release device are shown enlarged. The body 36 is supported above the slide rail 40 and is movable relative to the slide rail 40. One side of the body 36 is connected to a quick-release device, which is further coupled to the support arm 25. The support arm 25 includes a trunk portion 25b having an elongated shape and an end portion 25a located at one end of the trunk portion 25b and facing the workpiece. The support arm 25 is supported by the quick-release device through the trunk portion 25b, and the quick-release device also allows the support arm 25 to be locked relative to the body 36 or to enable the support arm 25 to move relative to the body 36. The trunk portion 25b has a substantially diamond cross-sectional shape, and the end portion 25a has a flat shape. The trunk portion 25b, the slide rail 40, and the crossbar 24 of FIG. 1 described above have length directions that are all parallel to each other, that is, they all extend in the same direction.

The quick-release device in particular includes a clamping device that includes a first clamping member 34 and a second clamping member 36. They have generally symmetrical shapes and are connected to the body 36 from the upper and lower portions of the body 36, respectively. Taking the first clamping member 34 as an example, the first clamping member 34 is made of a sheet material having a certain deformability (for example, metal), and includes a connecting piece 34c, a clamping portion 34b and a clamping surface 34a which are integrally formed and sequentially connected. The connecting piece 34c connects the first clamping member 34 to the body 36. The clamping portion 34b has a folded shape corresponding to two consecutive surfaces of four surfaces of the trunk portion 25b of the support arm 25 (i.e., two surfaces of the upper portion of the trunk portion 25 in FIGS. 2-3) and is substantially covered on the two surfaces. The end of the clamping portion 34b forms a clamping surface 34a. The structure of the second clamping member 36 is symmetrical with the structure of the first clamping member 34, but the clamping portion (not shown) in the second clamping member 36 corresponds to and substantially covers the other two continuous surfaces of the four surfaces of the trunk portions 25b of the support arm 25(i.e., two surfaces of the lower portion of the trunk portion 25 in FIGS. 2-3). The end of the second clamping member 36 also has a clamping surface 36a. The clamping surface 34a and the clamping surface 36a are also referred to as a first clamping surface and a second clamping surface in this embodiment.

The user switch in the quick-release device includes a handle 32. The handle 32 is located on the upper surface of the clamping surface 34a. The handle 32 has a handle portion 32a and a cam portion 32b connected the handle portion 32a. The cam portion 32b has a cam surface. The handle 32 is coupled to the clamping surface 34a and the clamping surface 36a by a connecting post 46. As clearly shown in FIG. 3, the cam portion 32b of the handle 32 has a hole (not shown) therein in which the end cap 46a formed at the upper end of the connecting post 46 is received. A washer 48 is sleeved on a cylinder 46b below the end cap 46a. Note that the end cap 46a is a portion of the connecting post 46, but the washer 48 is a different component than the connecting post 42. The washer 48 is located outside of the handle 32 and is movable relative to the connecting post 46. The movement of the washer 48 can be caused by the compression of the handle 32. Further, the above-mentioned clamping surfaces 34a and 36a are formed with openings (not shown) for the passage of the cylinder 46b of the connecting post 46. However, the connecting post 46 can be moved relative to the opening of the clamping surface 34a, and the connecting post 46 is fixed to the opening of the clamping surface 36a. The upper end of the end cap 46a is fixed to the periphery of the perforation 44 formed in the cam portion 32b of the handle 32.

Now the working principle of the quick-release device described above will be described. The state of the quick-release device shown in FIGS. 2-3 is in a locked state, i.e., the support arm 25 cannot be moved relative to the body 36 at this time. This is because the second clamping member 36 and the first clamping member 34 simultaneously wrap the trunk portion 25b of the support arm 25 and generate a frictional force on the surface of the trunk portion 25b. Such frictional force prevents the trunk portion 25b from moving relative to the second clamping member 36 and the first clamping member 34, and in particular the inner surface of their clamping portion. At this time, the handle 32 is in its locked position, and it can be seen that the periphery of the perforation 44 formed in the cam portion 32b of the handle 32 at this time is relatively far from the upper surface of the clamping surface 34a. Since the upper end of the end cap 46a is always fixed to the periphery of the perforation 44, the bottom surface of the cam portion 32b is pressed against the clamping surface 34a at a position closer to the clamping surface 36a, so that the second clamping member 36 and the first clamping member 34 simultaneously tightly wraps the trunk portion 25b of the support arm 25 to generate the above frictional force. The pressing of the bottom surface of the cam portion 32b against the clamping surface 34a overcomes the elasticity of the material of the first clamping member 34.

If the user wants to adjust the position of the support arm 25 relative to the body 36 in the state of the quick-release device shown in FIGS. 2-3, it is only necessary for the user to pull the handle 32 in the counterclockwise direction in FIGS. 2-3. That is, after such a pulling is completed, the handle protion 32a of the handle 32 will be vertically upward (not shown in the drawings). In addition to completing such a pulling, the handle 32 is now in its released position, and the periphery of the perforation 44 formed in the cam portion 32b of the handle 32 is relatively close to the upper surface of the clamping surface 34a. Since the upper end of the end cap 46a is always fixed to the periphery of the perforation 44, the bottom surface of the cam portion 32b is no longer pressed against the clamping surface 34a, and the clamping surface 34a comes to a position far from the clamping surface 36a due to the elasticity of the material of the first clamping member 34. The clamping surface 34a is far away from the clamping surface 36a, such that the second clamping member 36 and the first clamping member 34 no longer tightly wrap around the trunk portion 25b of the support arm 25, but rather create a certain gap between them. Therefore, the above-described frictional force that prevents the movement of the support arm 25 with respect to the body 36 is no longer present or greatly reduced, so that the user can manually pull the support arm 25 relative to the body 36 regardless of the position of the body 36. Therefore, the state of the quick-release device at this time is the released state.

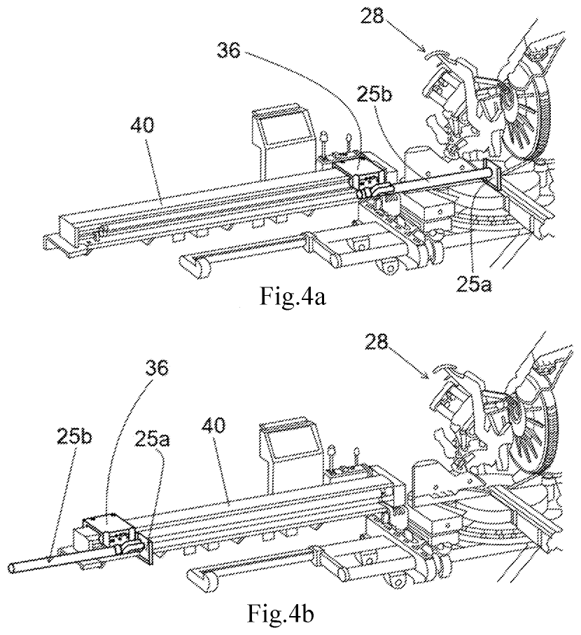

FIGS. 4a-4b respectively show the minimum and maximum distances of the workpiece relative to the miter saw 28 as permitted by the workpiece limiting device 31 described above. FIG. 4a shows that the body 36 is moved to the end of the end of the slide rail 40 closest to the miter saw 28, and the trunk portion 25b of the support arm 25 is also moved relative to the body 36 to a position such that the ends of the trunk portion 25b are substantially aligned with the body 36. In this state, the end surface 25a of the support arm 25 is closest to the miter saw 28. FIG. 4b shows that the body 36 is moved to the end of the slide rail 40 farthest from the miter saw 28, and the trunk portion 25b of the support arm 25 is also moved relative to the body 36 to a position such that the end of the trunk portion 25b close to the end surface 25a is substantially aligned with the body 36. In this state, the end surface 25a of the support arm 25 is farthest from the miter saw 28. Between the minimum distance and the maximum distance described above, the position of the end surface 25a of the support arm 25 relative to the miter saw 28 can be freely adjusted to meet the cutting needs of workpieces of different lengths, such as wood material.

Having thus described the embodiments of the invention, it will be understood by those skilled in the art that various modifications, and other structures and equivalents may be used without departing from the spirit of the invention. Accordingly, the above description should not be taken as limiting the scope of the invention as defined by the following claims.

For example, although the power tool mounted on the power tool stand and used in conjunction with the workpiece limiting device in the above embodiment is a miter saw, those skilled in the art should recognize that other types of power tools can also be used in conjunction with the workpiece limiting device of the utility model. For example, the power tool can be a circular saw, a table saw, or the like.

Furthermore, although the above embodiment specifically shows a quick-release device composed of a handle with cam surface and an elastic clamping member, the present invention is not limited to this specific structure. Other types of quick-release devices will also fall within the scope of the present invention as long as they are also manually operated by the user and are capable of locking the position of the support arm relative to the body of the workpiece limiting device.

1. A workpiece limiting device for a power tool, comprising:
a support arm adapted to contact a workpiece and limit the workpiece;
a body supporting the support arm, which is movable relative to the body; and
a quick-release device; allowing manual adjustment of a position of the support arm relative to the body, and locking the position without using an external tool.

2. The workpiece limiting device of claim 1, wherein the quick-release device is adapted to achieve the locking by applying a frictional force to the support arm.

3. The workpiece limiting device of claim 2, wherein the quick-release device further comprises a clamping device coupled to the body, wherein the clamping device is adapted to clamp the support arm to generate the frictional force.

4. The workpiece limiting device of claim 3, wherein the clamping device comprises a first clamping member and a second clamping member, wherein the first clamping member and the second clamping member are adapted to clamp the support arm together, and wherein the quick-release device further comprises a user switch to adjust a distance between the first clamping member and the second clamping member to achieve the locking.

5. The workpiece limiting device of claim 4, wherein the user switch is a handle having a cam surface, wherein the handle is adapted to rotate to cause the cam surface to press against one of the first clamping member and the second clamping member, so that the one of the first clamping member and or the second clamping member moves closer to the other one of the first clamping member and or the second clamping member to achieve the locking.

6. The workpiece limiting device of claim 4, wherein the first clamping member comprises a first clamping surface and the second clamping member comprises a second clamping surface, wherein the first clamping surface and the second clamping surface are substantially parallel to each other, and wherein the user switch is adapted to adjust a distance between the first clamping surface and the second clamping surface.

7. The workpiece limiting device of claim 3, wherein the support arm has a diamond-shaped cross section at least at a position proximate to the clamping device.

8. The workpiece limiting device of claim 2, further comprising a slide rail; adapted to be fixedly mounted relative to the power tool, wherein the body is movably supported on the slide rail.

9. The workpiece limiting device of claim 8, wherein the support arm defines a length direction parallel to a length direction of the slide rail.

10. The workpiece limiting device of claim 1, wherein the support arm is adapted to contact the workpiece from a length direction of the workpiece.

11. A power tool system, comprising:
a workpiece limiting device including
a support arm adapted to contact a workpiece and limit the workpiece;
a body supporting the support arm, which is movable relative to the body; and
a quick-release device allowing manual adjustment of a position of the support arm relative to the body, and locking the position without using an external tool;
a power tool stand to which the workpiece limiting device is mounted; and
a power tool mounted to the power tool stand.

12. The power tool system of claim 11, wherein the power tool is a miter saw.

13. The power tool system of claim 11, wherein the quick-release device is adapted to achieve the locking by applying a frictional force to the support arm.

14. The power tool system of claim 13, wherein the quick-release device further comprises a clamping device coupled to the body, wherein the clamping device is adapted to clamp the support arm to generate the frictional force

15. The power tool system of claim 14, wherein the clamping device comprises a first clamping member and a second clamping member, wherein the first clamping member and the second clamping member are adapted to clamp the support arm together, and wherein the quick-release device further comprises a user switch to adjust a distance between the first clamping member and the second clamping member to achieve the locking.

16. The power tool system of claim 15, wherein the user switch is a handle having a cam surface, wherein the handle is adapted to rotate to cause the cam surface to press against one of the first clamping member and the second clamping member, so that the one of the first clamping member or the second clamping member moves closer to the other one of the first clamping member or the second clamping member to achieve the locking.

17. The power tool system of claim 15, wherein the first clamping member comprises a first clamping surface and the second clamping member comprises a second clamping surface, wherein the first clamping surface and the second clamping surface are substantially parallel to each other, and wherein the user switch is adapted to adjust a distance between the first clamping surface and the second clamping surface.

18. The power tool system of claim 14, wherein the support arm has a diamond-shaped cross section at least at a position proximate to the clamping device.

19. The power tool system of claim 13, further comprising a slide rail adapted to be fixedly mounted relative to the power tool, wherein the body is movably supported on the slide rail.

20. The power tool system of claim 19, wherein the support arm defines a length direction parallel to a length direction of the slide rail.

21. The power tool system of claim 11, wherein the support arm is adapted to contact the workpiece from a length direction of the workpiece.
